(19) United States
(12) Patent Application Publication
(10) Pub. No.: US 2007/0010607 A1
(43) Pub. Date: Jan. 11, 2007

(54) Surface treatment composition and method for treating a surface

(76) Inventors: Kim R. Smith, Woodbury, MN (US); Altony J. Miralles, Eagan, MN (US); Keith E. Olson, Apple Valley, MN (US)

Correspondence Address: MERCHANT & GOULD PC, P.O. BOX 2903, MINNEAPOLIS, MN, 55402-0903, US

(21) Appl. No.: 11/473,369

(22) Filed: Jun. 22, 2006

Related U.S. Application Data
(60) Provisional application No. 60/694,119, filed on Jun. 24, 2005.

(51) Int. Cl. C08K 5/06; C08K 5/05

(52) U.S. Cl. 524/366; 524/543; 524/502; 524/474; 524/379

(57) ABSTRACT

A surface treatment composition is provided for increasing the gloss value of a surface. The surface treatment composition includes a nonsilicone gloss imparting component in an amount sufficient so that the surface treatment composition, when applied to a surface, provides the surface with an increased gloss value compared with the surface prior to application of the composition. The surface treatment composition can be water based or organic solvent based. In addition, the surface treatment composition can include a wetting agent to reduce the contact angle between the surface treatment composition and the surface. A method for using a surface treatment composition is provided.

This application claims priority to U.S. Application Ser. No. 60/694,119 that was filed with the United States Patent and Trademark Office on Jun. 24, 2005. The entire disclosure of U.S. Application Ser. No. 60/694,111 is incorporated herein by reference.

### FIELD OF THE INVENTION

The invention relates to a surface treatment composition and to a method for treating a surface. The surface treatment composition can be provided to impart gloss and water resistance to a surface.

### BACKGROUND OF THE INVENTION

A composition applied to a motor vehicle tire sidewall to impart a glossy shine and water resistance can be referred to as a tire dressing composition. Several tire dressing compositions are presently available. One commercially available tire dressing composition is sold under the name Black Magic® Tire Wet® Gel from Blue Coral-Slick 50, Ltd. Exemplary United States patents that describe compositions that can be applied to a motor vehicle tire to provide a gloss include, for example, U.S. Pat. No. 5,844,007 to Kijima et al., U.S. Pat. No. 5,989,640 to Kijima et al., U.S. Pat. No. 5,432,217 to O'Lenick, and U.S. Pat. No. 5,017,221 to Legrow et al.

Various techniques are available for applying tire dressing compositions to a motor vehicle tire sidewall. For example, the compositions can be applied by hand by wiping onto the sidewall or spraying onto the sidewall. In addition, the compositions can be applied to a motor vehicle tire sidewall by an automated process during a car wash operation. Exemplary automated techniques for applying a tire dressing composition to a motor vehicle tire sidewall are disclosed by U.S. Pat. No. 6,660,335 and U.S. Patent Publication No. US 2004-0022955 A1.

Many compositions are available for application to motor vehicle tires, dashboards, and door liners to improve appearance, and include polysiloxanes, petroleum distillates, or mixtures of polysiloxanes and petroleum distillates.

### SUMMARY OF THE INVENTION

A surface treatment composition is provided according to the invention. The surface treatment composition can be provided as an aqueous surface treatment composition or as a non-aqueous surface treatment composition. The surface treatment composition can provide a surface with a glossy appearance and water resistance.

A surface treatment composition that contains water is provided according to the invention. The surface treatment composition includes a nonsilicone gloss imparting component, a wetting agent, and water. The nonsilicone gloss imparting component can be provided in an amount sufficient so that the surface treatment composition, when applied to a surface, provides the surface with an increased gloss value compared with the surface prior to application of the composition. The wetting agent can be provided in an amount sufficient so that the composition, when applied to the surface, provides a contact angle between the surface treatment composition and the surface of less than 90°. The water can be provided in the surface treatment composition in an amount of at least about 40 wt. % based on the weight of the surface treatment composition.

A surface treatment composition can be provided containing organic solvent. The surface treatment composition includes a nonsilicone gloss imparting component in an amount sufficient so that the surface treatment composition, when applied to a surface, provides the surface with an increased gloss value compared with the surface prior to application of the composition. An organic solvent can be provided wherein the nonsilicone gloss imparting component and the organic solvent are different.

A method for shining a surface is provided according to the invention. The method includes a step of applying a surface treatment composition to a surface.

### DETAILED DESCRIPTION OF THE INVENTION

Surface treatment compositions are available that, after application to a surface, provide the surface with a glossy appearance. The glossy appearance can be characterized as a wet appearance when the surface looks wet. The surface treatment composition can, if desired, provide the surface with water resistance. Water resistance refers to the tendency of the composition to remain on the surface to which it has been applied even after contact with water. When the surface treatment composition provides a surface with water resistance, the surface treatment composition can be characterized as providing a surface with a glossy appearance and water resistance.

The surface treatment composition can be provided as a concentrate or as a use composition. In general, a use composition refers to the composition that can be applied to a surface to provide a glossy appearance. A concentrate refers to a composition that can be diluted to provide a use composition. The concentrate can be diluted with a carrier (e.g., water or an organic solvent). A use composition can be referred to as a ready to use composition.

The surface treatment composition, after application to a surface, can be characterized as dry when at least 90% of the carrier has evaporated. The carrier refers to the water or organic solvent provided in the use composition to assist with the delivery of the use composition to a surface. The surface treatment composition can be characterized as wet when less than 90% of the carrier has evaporated. The surface treatment composition applied to a surface can be characterized as a film. The film can be provided as a liquid film or as a nonliquid film. The liquid film can be characterized as dry or wet depending upon the amount of the carrier that has evaporated. The nonliquid film can be characterized as dry or wet depending upon the amount of the carrier that has evaporated. The liquid film can remain as a liquid that can be wiped off. The nonliquid film can be provided as tacky to touch or nontacky to touch.

The surface treatment composition can be applied to a variety of surfaces. The surface treatment composition can be named depending upon the surface to which it can be applied or the environment in which it can be used. The surface treatment composition can be referred to as a vehicle protectant when used to provide a glossy appearance on vinyl, leather, plastics, rubber, and other visible surfaces of automobiles, trucks, boats, trains, planes, and other vehicles. The surface treatment composition can be applied to various surfaces in addition to those found on a vehicle to provide the surface with a glossy appearance and optional water resistance. Exemplary surfaces include polymeric surfaces, metal surfaces, wood surfaces, mineral surfaces, leather surfaces, glass surfaces, and coated surfaces. Exemplary polymeric surfaces include rubber, vinyl, and plastics. Exemplary plastic surfaces include polyethylene terephthalate, polyethylene, polypropylene, and polyamide. The rubber surfaces can include those found on vehicle tires, and vehicle bumpers. Exemplary rubber surfaces include natural and synthetic rubber, such as, polybutadiene. Exemplary metal surfaces include steel, brass, and aluminum. Exemplary wood surfaces include those surfaces found on furniture and various other applications including doors, woodwork, etc. Exemplary leather surfaces include those surfaces found on furniture, clothing, and upholstery such as that found inside a vehicle. Exemplary mineral surfaces include counters found in, for example, kitchens. The surface treatment composition can be referred to as a furniture treatment composition when it is provided for application to furniture. The surface treatment composition can be referred to as a lube when it is used for processing containers on a conveyor for filling or packaging the containers. Containers can be provided as cans or bottles, and can be provided from materials such as plastics, metal, and glass. The various surfaces available for application of the surface treatment composition can be found on outdoor furniture and indoor furniture.

When the surface treatment composition is provided for use on a tire, it can be referred to as a tire dressing composition. In general, a tire dressing composition refers to a composition that can be applied to the sidewalls of a tire to provide the tires with a glossy appearance.

A glossy appearance refers to the presence of an increased gloss value of a surface as a result of the application of the surface treatment composition to the surface. In general, gloss value increases with increased refractive index. The increased gloss value refers to a gloss value for a surface that is greater after application of the surface treatment composition to the surface than before application of the surface treatment composition to the surface. The gloss value can be measured using a Gardner gloss meter measured at 60°. Other commonly used angles used for measuring gloss value include 30° and 90°. An increased gloss value can refer to an increase in gloss value of at least about 5%. A more desired increased gloss value can be an increase in gloss value of at least about 15%.

Water resistance refers to the ability of the composition to maintain a glossy appearance on a surface after application of water thereto. In various applications of the surface treatment composition to a surface, it is expected that water may contact the surface as a result of rain. Accordingly, it can be desirable for the surface treatment composition to provide a glossy appearance on a surface, and for the surface to maintain the glossy appearance even after application of water as a result, for example, of rain. For example, in the case of a tire sidewall, it can be desirable for the glossy appearance of the tire sidewall to remain after a rain storm or after the tire travels through a puddle to avoid having to re-apply the surface treatment composition to the tire sidewall to restore the glossy appearance after each rain. When the surface treatment composition provides water resistance, the surface treatment composition can be characterized as providing a glossy appearance and water resistance. It should be understood that the characterization of the surface treatment composition as being water resistant should not be construed as requiring that the composition possess permanent water resistance. It is expected that the composition will wear off eventually as a result of contact with water from, for example, the road, from rain, or from a car wash. In general, a user can periodically apply the tire dressing composition to the surface to maintain a glossy appearance. In addition, the surface treatment composition can be provided having a fairly low level of water resistance so that the surface treatment composition can be readily removed from a surface by application of water. A water soluble surface treatment composition may be desirable for those who want to provide a surface having a glossy appearance for a particular event such as an automobile show and then remove the surface treatment composition.

The surface treatment composition can be provided so that it resists absorption into the surface upon which it is applied. In certain applications, it is expected that absorption into a surface may provide detrimental effects. For example, in the case of a surface treatment composition that is applied to a tire surface, absorption into the tire surface may cause a weakening or loss of strength of the tire. The surface treatment composition, when provided as a tire dressing composition, can be characterized as having an absorption resistance in a tire of less than about 10 wt. %. That is, when the surface treatment composition is applied to a tire and wiped or leveled, less than 10 wt. % of the surface treatment composition remaining absorbs into the tire. The surface treatment composition can be provided so that it exhibits an absorption resistance in a tire of less than about 5 wt. %, or less than about 1 wt. %. In addition, the surface treatment composition can be provided so that it resists leaching or removing material from a surface. In certain applications, it is expected that leaching components from a surface may provide detrimental effects. For example, in the case of a surface treatment composition that is applied to a tire surface, leaching components from the tire may cause a weakening or loss of strength of the tire. The surface treatment composition can provide a level of leaching of less than about 0.1 wt. %. The level of leaching refers to the removal of components from the tire and the weight percent is based on the weight loss of the tire and does not include the surface treatment composition.

A tire dressing composition that imparts a glossy appearance to tires can be referred to as a “tire shine.” The surface treatment composition can be provided containing a nonsilicone gloss imparting component. The nonsilicone gloss imparting component is a component of the composition that is responsible for imparting a glossy appearance when the surface treatment composition is applied to a surface. The surface treatment composition can be provided as an aqueous composition or as a non-aqueous composition. In addition, the surface treatment composition can include a wetting agent to help the surface treatment composition wet a surface. The surface treatment composition can include additional components such as carrier, wetting agents, thickening agents, drying agents, film forming agents, UV absorbers, UV stabilizers, antioxidants, pH modifiers, preservatives, solidifying agents, and aesthetic agents.

Nonsilicone Gloss Imparting Component

The surface treatment composition includes a nonsilicone gloss imparting component so that the surface treatment composition, when applied to a surface, provides the surface with an increased gloss value. The nonsilicone gloss imparting component is a component that does not include repeating siloxane groups such as repeating dimethylsiloxane groups, and preferably does not contain the repeating group —(SiR₂—O)ₙ— where R can be substituents containing carbon that bonds to silicon and n is 2 or greater. Preferably, the nonsilicone gloss imparting component does not include a siloxane group.

The nonsilicone gloss imparting component can be selected to provide physical properties that are desirable for a surface treatment composition providing increased gloss value. These physical properties include a desired level of water insolubility, a desired glass transition temperature (T_{g}) or melting point (Tₘ), a desired refractive index, and a desired density. In general, it is desirable for the nonsilicone gloss imparting component to be sufficiently water insoluble so that the surface treatment composition resists removal from a surface as a result of contact with water. For example, the nonsilicone gloss imparting component can be provided so that less than about 5 wt. % of a sample of the nonsilicone gloss imparting component is soluble in water at room temperature (20° F). Preferably, the nonsilicone gloss imparting component is sufficiently water insoluble so that less than about 1 wt. % of a sample of the nonsilicone gloss imparting component is soluble in water at room temperature (20° F.). The water solubility is determined based upon combining a volume of the nonsilicone gloss imparting component with an equal volume of water, and the weight percent is based upon the weight percent of the nonsilicone gloss imparting component. It is generally desirable for the nonsilicone gloss imparting component to resist freezing after it is applied to a surface. In general, components that freeze can often form a cloudy appearance. In the case of a surface treatment composition, a cloudy appearance may cause the gloss value to decrease. Accordingly, it is generally desirable for the nonsilicone gloss imparting component to have a glass transition temperature (T_{g}) or melting point (Tₘ) that is below the ambient conditions to which the nonsilicone gloss imparting component will be exposed. For example, the nonsilicone gloss imparting component can have a T_{g} or Tₘ that is less than about 0° C., and preferably less than −10° C. When the nonsilicone gloss imparting component is a polymeric material, the glass transition temperature (T_{g}) may be more appropriate for characterizing the temperature at which the material “freezes.” When the nonsilicone gloss imparting component is a non-polymeric material (e.g., a compound), the melting point (Tₘ) may be more appropriate for characterizing the temperature at which the material freezes. The nonsilicone gloss imparting component can be provided having a sufficient refractive index so that sufficient gloss of a surface containing the surface treatment composition is achieved. The nonsilicone gloss imparting component can have a refractive index that provides a desired gloss value. In general, a higher refractive index can generally correspond to a higher gloss value. For example, the nonsilicone gloss imparting component can have a refractive index of greater than about 1.30 and can have a refractive index of greater than about 1.40. The nonsilicone gloss imparting component can be provided having a density that is greater than water. By providing a density that is greater than water, it is expected that the nonsilicone gloss imparting component will be less likely to be displaced by water as a result of application of water to a surface that has been contacted by the surface treatment composition. Although it is desirable for the nonsilicone gloss imparting component to have a density greater than about 1.00 g/cm³ to help provide water resistance, this property of density is not a required property.

The nonsilicone gloss imparting component can be any nonsilicone component that, when provided in the surface treatment composition, provides a surface to which it is applied with a desired increase in gloss value. The properties of water insolubility, glass transition temperature melting point, and refractive index can be relied upon to select the nonsilicone imparting component. In addition, the density can be relied upon to help select the nonsilicone gloss imparting component. Exemplary nonsilicone gloss imparting components that can be used include those that can be characterized as polymers or organic polar compounds that satisfy the desired properties of solubility in water of less than 5 wt. %, glass transition temperature or melting point of less than about 0° C., and a refractive index of greater than about 1.30. Exemplary polymers include polyalkylene glycols, polyolefins, and mixtures thereof. Exemplary polyalkylene glycols include polypropylene glycol, polybutylene glycol, and mixtures thereof. Exemplary polyalkylene glycols (such as polypropylene glycols) include those having a molecular weight of about 1,000 to about 50,000. Exemplary polyolefins include poly(alpha)olefins, polyisobutylene, polypropylene, polyethylene, and mixtures thereof. Exemplary poly(alpha)olefins include polybutylene, polydecene, and mixtures thereof It should be understood that the reference to a polymer refers to homopolymers containing the identified repeating unit and copolymers wherein at least one of the repeating units is the identified repeating unit. For example, the reference to polypropylene glycol includes homopolymers of polypropylene glycol and copolymers of polypropylene glycol. Exemplary polar molecules include those having two or more ester groups or derivatives thereof, and have a molecular weight greater than 400. The organic polar compounds can include additional functionality. In addition, the organic polar compounds can include two or more ester groups. An exemplary polar compound having two or more ester groups includes glyceride. An exemplary type of glyceride that can be used includes triglycerides. Exemplary triglycerides include canola oil, olive oil, rape seed oil, soybean oil, and corn oil.

The surface treatment composition can include the nonsilicone gloss imparting component in an amount sufficient to provide a surface containing the surface treatment composition with an increased gloss value. Gloss value can be determined by measurement with a Gardner glass meter. An increased gloss value refers to an increase in the gloss value of the surface after treatment with the surface treatment composition and after, and either before or after the surface has dried, compared with the surface prior to treatment with the surface treatment composition. In the case of the use composition, the surface treatment composition can be provided having a concentration of the nonsilicone gloss imparting component in an amount of at least about 1 wt. %, based on the weight of the use composition. The amount of the nonsilicone gloss imparting component can be provided at less than about 50 wt. %. The concentration of the nonsilicone gloss imparting component can be provided at about 5 wt. % to about 40 wt. %, and can be provided at about 10 wt. % to about 30 wt. %.

Carrier Component

The surface treatment composition can include a carrier component that helps or assists in the delivery of the surface treatment composition to a surface. The carrier component can be water or organic solvent. In addition, the carrier component can include water and organic solvent.

The surface treatment composition can be provided as an aqueous or non-aqueous composition. When provided as an aqueous composition, the surface treatment composition contains water. When provided as a non-aqueous composition, the surface treatment composition contains less than about 5 wt. % water and preferably about 1 wt. % water based on the weight of the surface treatment composition. The non-aqueous composition can contain no water although it is expected that at least a small amount of water can be present. When provided as an aqueous use composition, the surface treatment composition can contain at least about 40 wt. % water. In addition, the aqueous use composition can contain at least about 60 wt. % water, and can contain at least about 70 wt. %. In general, the aqueous surface treatment composition can contain less than about 99 wt. % water in order to provide room for the remaining components of the composition including the nonsilicone gloss imparting component. The weight percent is based on the weight of the use composition.

The surface treatment composition can include an organic solvent. The organic solvent can be provided to assist with delivery or application of the surface treatment composition to a surface. Various solvents that can be used include nonpolar solvents and polar solvents. Exemplary nonpolar solvents include toluene, cumene petroleum distillate, and mineral oil. Exemplary polar solvents include esters, ethers, glycol ethers, amides, alcohols, and volatile silicones. Exemplary esters include triglyceride, ethyl acetate, soy methyl ester, and dipropylene glycol methyl acetate. An exemplary ether includes dioctyl ether. Exemplary glycol ethers include butyl cellusolve, tripropylene glycol, and dipropylene glycol methyl ether. An exemplary amide includes dimethylformamid. Exemplary alcohols include alkane polyols, aromatic polyols, and alicyclic alcohols. Exemplary alkane polyols include tetradecanol; 2-ethyl-2-methyl-1,3 propanediol; 2-ethyl-1,4-butanediol; 1,3-hexanediol; and 1,6-hexanediol. Exemplary aromatic alcohols include 3-phenyloxy-1,2-propanediol and 3-benzyloxy-1,2-propanediol. An exemplary alicyclic diol includes 5-cycloocetane-1,2-diol. An exemplary volatile silicone includes cyclic silicones such as the product available under the name Dow Corning Fluid OS-2 from Dow Corning.

The organic solvent can be provided as a low VOC (volatile organic compound) solvent. In general, a low VOC solvent refers to a solvent exhibiting a vapor pressure of less than 0.1 mm Hg at 20° C. In addition, organic solvents can be used that are not low VOC or that are VOC exempt such as Dow Corning Fluid OS-2 from Dow Corning. It should be understood that certain organic solvents can be considered nonsilicone gloss imparting agents. When the organic solvent can be considered a nonsilicone gloss imparting agent, another and different nonsilicone gloss imparting agent can be included in the surface treatment composition. In general, a mixture of nonsilicone gloss imparting agents can be used wherein one nonsilicone gloss imparting agent may be responsible for providing greater gloss value and another nonsilicone gloss imparting agent can be responsible for providing enhanced or desired fluid delivery properties.

The organic solvent can be included in the use composition in an amount sufficient to provide the surface treatment composition with desired delivery properties. It should be understood that the organic solvent is an optional component and can be excluded from the surface treatment composition. When the surface treatment composition includes an organic solvent as part of the use composition, it can be included in an amount of at least about 0.5 wt. % and it can be provided in the amount of less than about 40 wt. %. In addition, the use composition can contain at least about 1 wt. % organic solvent and less than about 20 wt. % organic solvent, less than about 10 wt. % organic solvent, or less than about 5 wt. % organic solvent.

Wetting Agent

A wetting agent can be included in the surface treatment composition to provide a surface contact angle between the surface and the surface treatment composition of less than 90°. The wetting agents preferably provides the contact angle as less than about 45°. The selection of the wetting agent and the amount of the wetting agent in the surface treatment composition can provide for the desired contact angle between the surface treatment composition and the surface the surface treatment composition contacts.

The wetting agent can be an emulsifier, and can be a surfactant. Exemplary surfactants that can be used include those surfactants that are characterized as cationic surfactants, anionic surfactants, nonionic surfactants, amphoteric surfactants, zwitterionic surfactants, or mixtures thereof. A preferred surfactant can be one that has an HLB value that enhances the stability of a dispersion or emulsion of the nonsilicone gloss imparting component in water. The surfactant can have an HLB value of about 2 to about 20. In addition, the surfactant can have an HLB value of about 5 to about 18, and can have an HLB value of about 7 to about 15.

The surfactant can be provided in the surface treatment composition in an amount sufficient to provide the surface treatment composition with stability. In general, stability refers to the general lack of phase separation. When the surface treatment composition is provided as an emulsion, stability refers to the continued existence of the composition as an emulsion for a time period of at least about 1 week when held at 20° C. In addition, it can be recognized that at a certain concentration, the amount of surfactant present may have a detrimental effect on water resistance. For example, increasing the surfactant concentration may cause the surface treatment composition to become more readily removable in the presence of water. By way of example, the surface treatment composition can be provided having a surfactant component concentration of less than about 10 wt. %, based on the weight of the use composition. The surface treatment composition can be provided having a surfactant component concentration of about 0.2 wt. % to about 2 wt. %.

The anionic surfactant component can include an anionic surfactant or a mixture of anionic surfactants. Anionic surfactants are often desirable because of their wetting properties. The anionic surfactants that can be used according to the invention include any anionic surfactant that provides a desired level of wetting properties. Exemplary groups of anionic surfactants include carboxylates, isothionates, sulfonates, and sulfates. Exemplary surfactants that can be provided in the anionic surfactant component include aryl sulfonates, alkyl aryl sulfonates, alkane sulfonates, alkyl ester sulfonates, alpha olefin sulfonates, alkyl ether sulfates, alkyl sulfates, and alcohol sulfates.

Exemplary alkyl aryl sulfonates that can be used can have an alkyl group that contains 1 to 24 carbon atoms and the aryl group can be at least one of benzene, toluene, and xylene. An exemplary alkyl aryl sulfonate includes linear alkyl benzene sulfonate. An exemplary linear alkyl benzene sulfonate includes linear dodecyl benzyl sulfonate that can be provided as an acid that is neutralized to form the sulfonate. Exemplary alkyl aryl sulfonates include xylene sulfonate and cumene sulfonate.

Exemplary alkane sulfonates that can be used can have an alkane group having 6 to 24 carbon atoms. Exemplary alkane sulfonates that can be used include secondary alkane sulfonates. An exemplary secondary alkane sulfonate includes sodium C₁₄-C₁₇ secondary alkyl sulfonate commercially available as Hostapur SAS from Clariant.

Exemplary alkyl ester sulfonates that can be used include those having an alkyl group containing 6 to 24 carbon atoms, and an example of which is alkyl methyl ester sulfonate.

Exemplary alpha olefin sulfonates that can be used include those having alpha olefin groups containing 6 to 24 carbon atoms.

Exemplary alkyl ether sulfates that can be used include those having between about 1 and about 10 repeating alkoxy groups, between about 1 and about 5 repeating alkoxy groups. In general, the alkoxy group will contain between about 2 and about 4 carbon atoms. An exemplary alkoxy group is ethoxy. An exemplary alkyl ether sulfate is sodium lauryl ether ethoxylate sulfate and is available under the name Steol CS-460.

Exemplary alkyl sulfates that can be used include those having an alkyl group containing 6 to 24 carbon atoms. Exemplary alkyl sulfates include sodium lauryl sulfate and sodium lauryl/myristyl sulfate.

The anionic surfactant can be neutralized with an alkaline metal salt, an amine, or a mixture thereof. Exemplary alkaline metal salts include sodium, potassium, and magnesium. Exemplary amines include monoethanolamine, triethanolamine, and monoisopropanolamine. If a mixture of salts is used, an exemplary mixture of alkaline metal salt can be sodium and magnesium, and the molar ratio of sodium to magnesium can be between about 3:1 and about 1:1.

Exemplary amphoteric surfactants include betaines, amine oxides, silicone copolymers, sultaines, amphoacetates, imidazoline derivatives, and mixtures thereof.

The zwitterionic surfactants that can be used include β-N-alkylaminopropionates, N-alkyl-β-iminodipropionates, imidazoline carboxylates, N-alkylbetaines, sulfobetaines, sultaines, amine oxides and polybetaine polysiloxanes. Exemplary polybetaine polysiloxanes have the formula: 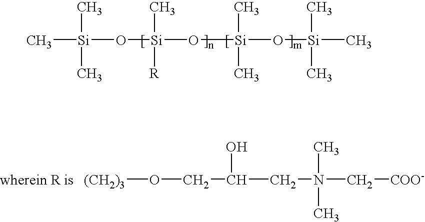
n is 1 to 100 and m is 0 to 100, preferably 1 to 100. Preferred polybetaine polysiloxanes are available under the name ABIL® from Goldschmidt Chemical Corp. Preferred amine oxides that can be used include alkyl dimethyl amine oxides containing alkyl groups containing 6 to 24 carbon atoms. An exemplary amine oxide is lauryl dimethylamine oxide.

Exemplary nonionic surfactants include alcohol alkoxylates, ethylene oxide-propylene oxide copolymers, alkyl polyglycosides, alkanolamides, and mixtures thereof.

Exemplary nonionic surfactants include nonionic block copolymers, alcohol alkoxylates, alkyl polyglycosides, polyglycosides, alkanolamides, and mixtures thereof. Exemplary alcohol alkoxylates include alcohol ethoxylates, alcohol propoxylates, alkyl phenol ethoxylate-propoxylates, and mixtures thereof.

Exemplary nonionic block copolymer surfactants include polyoxyethylene-polyoxypropylene block copolymers and polyoxypropylene-polyoxybutylene block copolymers. Exemplary polyoxyethylene-polyoxypropylene block copolymers that can be used have the formulae:
(EO)ₓ(PO)_{y}(EO)ₓ
(PO)_{y}(EO)ₓ(PO)_{y}
(PO)_{y}(EO)ₓ(PO)_{y}(EO)ₓ(PO)_{y}
wherein EO represents an ethylene oxide group, PO represents a propylene oxide group, and x and y reflect the average molecular proportion of each alkylene oxide monomer in the overall block copolymer composition. Preferably, x is from about 1 to about 100 and y is about 1 to about 100. It should be understood that each x and y in a molecule can be different. The total polyoxyethylene component of the block copolymer can be at least about 20 mol-% of the block copolymer and can be at least about 30 mol-% of the block copolymer. The material can have a molecular weight greater than about 1,500, and greater than about 2,000. Although the exemplary polyoxyethylene-polyoxypropylene block copolymer structures provided above have 3 blocks and 5 blocks, it should be appreciated that the nonionic block copolymer surfactants according to the invention can include more or less than 3 and 5 blocks. In addition, the nonionic block copolymer surfactants can include additional repeating units such as butylene oxide repeating units. Furthermore, the nonionic block copolymer surfactants that can be used according to the invention can be characterized heteric polyoxyethylene-polyoxypropylene block copolymers. Exemplary sheeting agents that can be used according to the invention are available from BASF under the name Pluronic, and an exemplary EO-PO co-polymer that can be used according to the invention is available under the name Pluronic N3. Exemplary polyoxypropylene-polyoxybutylene block copolymers include those having the formulae:
(PO)_{y}(BO)_{z}(PO)_{y}
(BO)_{z}(PO)_{y}(BO)_{y}
(BO)_{z}(PO)_{y}(BO)_{z}(PO)_{y}(BO)_{z}
wherein PO represents a propylene oxide group, BO represents a butylene oxide group, and y and z reflect the average molecular portion of each alkylene oxide monomer in the overall block copolymer composition. Preferably, y and z are each about 1 to about 100.

A desirable characteristic of the nonionic block copolymers is the cloud point of the material. The cloud point of nonionic surfactant of this class is defined as the temperature at which a 1 wt-% aqueous solution of the surfactant turns cloudy when it is heated. Nonionics tend to provide desired detersive properties at near their cloud point.

The alcohol alkoxylate surfactants that can be used according to the invention can have the formula:
R(AO)ₓ—X
wherein R is an alkyl group containing 6 to 24 carbon atoms, AO is an alkylene oxide group containing 2 to 12 carbon atoms, x is 1 to 20, and X is hydrogen or an alkyl or aryl group containing 1-12 carbon atoms. The alkylene oxide group is preferably ethylene oxide, propylene oxide, butylene oxide, or mixture thereof. In addition, the alkylene oxide group can include a decylene oxide group as a cap.

The alkyl polyglycoside surfactants that can be used according to the invention can have the formula:
(G)ₓ-O—R
wherein G is a moiety derived from reducing saccharide containing 5 or 6 carbon atoms, e.g., pentose or hexose, R is a fatty aliphatic group containing 6 to 24 carbon atoms, and x is the degree of polymerization (DP) of the polyglycoside representing the number of monosaccharide repeating units in the polyglycoside. The value of x can be between about 0.5 and about 10. R can contain 10-16 carbon atoms and x can be 0.5 to 3.

Alkanolamides that can be used as nonionic surfactants include alkanolamides having the following formula: 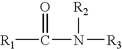
wherein R₁ is C₆-C₂₀ alkyl group, R₂ is hydrogen or a Cl-C₃, and R₃ is hydrogen or a C₁-C₃ alkyl group. An exemplary alkanolamide is available as cocodiethanolamide.

Exemplary cationic surfactants that can be used include quaternary ammonium compounds and amine salts including those having the following formula: 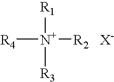
wherein R₁, R₂, R₃, and R₄ can, independently of each other, be hydrogen, C₁-C₂₄ branched, linear, alkyl, aryl, or aralkyl groups, and X can be an anion such as a halide, methosulfate, ethosulfate, carbonate, phosphate, sulfate, etc., and can be anion that contains alkoxy, ether, amide, or ester functionality. Exemplary quaternary ammonium compounds include propoxylated quaternary ammonium compounds. In general, propoxylated quaternary ammonium compounds include at least one R group containing repeating propoxy groups. Preferably, the group R contains at least 5, and more preferably at least 10, repeating propoxy groups, and can contain up to about 80 repeating propoxy groups. An exemplary propoxylated quaternary ammonium compound is available under the name VARIQUAT CC42NS from Degussa, and has the chemical name poly(oxy(methyl-1,2-ethanediyl)), alpha-(2-(diethylmethyl ammonia)ethyl)-omega-hydroxy chloride.
Thickening Agents

The surface treatment composition can include a thickening agent in an amount sufficient to provide the composition with a desired viscosity. The viscosity of the surface treatment composition can be selected or controlled depending upon the application method of the composition. The surface treatment composition can be provided having a viscosity that is about as thin as water and can be provided having a viscosity sufficiently high so that the composition can be characterized as a gel. In addition, it should be understood that the thickening agent component is an optional component and need not be included in the surface treatment composition.

Exemplary thickening agents that can be used in the surface treatment composition include gums, pectins, cellulose, polyacrylates, copolymers of polyacrylates, polyurethanes, copolymers of polyurethanes, and mixtures thereof. Exemplary gums include xanthan gum and guar gum. Exemplary polyacrylates are available under the names ACUSOL 820 from Rohm and Haas, and PEMULEN 1622 from Noveon. An exemplary polyurethane is available under the name AQUASOL 30 from Noveon. Additional exemplary thickening agents include nonsilicone gloss imparting components. When the composition includes a nonsilicone gloss imparting component as a thickening agent, it should be understood that the nonsilicone gloss imparting component and the thickening agent are different components. An exemplary nonsilicone gloss imparting component that can be used as a thickening agent includes polyisobutylene.

The surface treatment composition can contain a sufficient amount of the thickening agent to provide the composition with a desired viscosity. If desired, the surface treatment composition can be provided as sheer thinning. The viscosity of the surface treatment composition can be provided at a level that is desirable for a given type of application. In general, the viscosity of the surface treatment composition can be greater than about the viscosity of water. In addition, the upper limit on the viscosity can vary and depends on the type of application to a surface. In the case where the surface treatment composition is intended to be applied to a surface by spraying, the surface treatment composition can have a viscosity of about 100 cps to about 3,000 cps. When the surface treatment composition is intended for squirting onto a surface or applicator (e.g., sponge, cloth, rag, or leveling material) the viscosity can be about 10 cps to about 1 million cps. The amount of the thickening agent in the surface treatment composition can vary depending upon the selection of the thickening agent and the desired viscosity of the surface treatment composition. An exemplary range of the thickening agent in the surface treatment composition can be about 0.01 wt. % to about 2 wt. % based on the weight of the use composition.

Drying Agents

Drying agents can be included in the surface treatment composition to help the composition achieve a less tacky feel after application to a surface. Drying agents may actually increase the rate of drying of the surface treatment composition. Drying agents can be included in the surface treatment composition to assist with the drying of the surface treatment composition. Exemplary drying agents that can be used in the surface treatment composition include polar organic compounds having a melting point greater than room temperature. The exemplary drying agents preferably have a melting point greater than 20° C., and even more preferably, greater than about 30° C. Exemplary polar organic compounds that can be used as drying agents include humectants. Exemplary humectants include glycerine, propylene glycol, sorbitol, alkyl polyglycosides, polybetaine, polysiloxanes, or mixtures thereof. Exemplar polar organic compounds include cetyl alcohol and methyl stearamide.

The drying agent is an optional component of the surface treatment composition and need not be included in the surface treatment composition. When the drying agent is included in the surface treatment composition, it can be included at a concentration of about 0.01 wt. % to about 5 wt. % based on the weight of the surface treatment composition. In addition, the drying agent can be included in the surface treatment composition in an amount of about 0.01 wt. % to about 1 wt. % based on the weight of the use composition.

Film Forming Agents

The surface treatment composition can include a film forming agent to enhance the durability and reduce soil pick up on a surface. Exemplary film forming agents include polyvinyl alcohols, polyvinyl acetates, polyacrylates, copolymers of polyacrylates, polysilanes, polyethylene, copolymers of polyethylene, polypropylene, copolymers of polypropylene, polyamides, polyesters, polyvinyl pyrrolidones, amino alkoxy silicone, amino silicone, waxes, and mixtures thereof.

Exemplary polyvinyl alcohols include homopolymers of polyvinyl alcohol and copolymers of polyvinyl alcohol. The polyvinyl alcohol can have degrees of hydrolysis of about 50% to about 100%, can be available as an emulsion, as a powder, or as a crystal, can have a water solubility that can be characterized as water soluble to water insoluble.

Polyvinyl alcohol generally has the repeating structure —CH₂CHOH—. Polyvinyl alcohol is commercially available and is well known to the art and literature, and is typically made by the alcoholysis of polyvinyl acetate (PVAC) which generally has the repeating structure —CH₂CH(COOCH₃)—. When provided as a film former, polyvinyl alcohol component can have a weight average molecular weight of about 22,000 to about 250,000, depending on the grade of the polymer. It is generally recognized that, as the molecular weight decreases, the water solubility increases. Thus, the weight average molecular weight can be about 84,000 to about 110,000 and the number average molecular weight can be about 22,000 to about 50,000 to provide water solubility. By providing a lower molecular weight of the polyvinyl alcohol, increased flexibility or pliability can be achieved.

Because polyvinyl alcohol is often prepared by alcoholysis of polyvinyl acetate, commercially available polyvinyl alcohol often contains residual amounts of polyvinyl acetate. In commercially available polyvinyl alcohol, it is believed that the polyvinyl acetate content may be about 0.5 wt. % to about 20 wt. % based on the dry weight. Exemplary sources of polyvinyl alcohol that can be used in the invention are described in U.S. Pat. Nos. 5,137,070 and 5,240,056 to Kansupada et al., the disclosures of which are incorporated by reference in their entirety.

Exemplary waxes that can be used as the film forming agent include natural waxes such as carnuba wax, montan wax, candelilla wax, and mixtures thereof.

An exemplary amino alkoxy silicone that can be used is available under the name Dow Corning 531 from Dow Corning. An exemplary amino silicone that can be used is available under the name Dow Corning 929 Emulsion from Dow Corning.

The film forming agent is an optional component of the surface treatment composition and need not be included in the surface treatment composition. When it is included in the surface treatment composition, it can be provided in an amount of about 0.1 wt. % to about 20 wt. % based on the weight of the use composition. A preferred amount of film forming agent can be about 0.5 wt. % to about 10 wt. %.

UV Absorbers and UV Stabilizers

The surface treatment composition can include UV absorbers and UV stabilizers to provide for protection against UV light. Exemplary UV absorbers or UV stabilizers include 2-hydroxy-4-methoxybenzophenone (e.g., CYASORB UV 9); 2,2′-dihydroxy-4-n-octylbenzophenone (e.g., CYASORB UV 531); N-(p-ethoxycarbonylphenyl)-N′-methyl-N′phenyl formamidine (e.g., GIVSORB UV2); 2-(2′hydroxy-5′methyl-phenyl)benzotriazole (e.g., TINUVIN P); Other substituted benzotriazoles (e.g., TINUVIN 109, TINUVIN 123, TINUVIN 171, TINUVIN 292, TINUVIN 327, TINUVIN 328, TINUVIN 384); benzophenone-3(2-hydroxy-4-methoxybenzophenone)(e.g. UVASORB MET); 2-(2′hydroxy-3′methyl-phenyl)benzotriazole (e.g., UVASORB SV); 2-hydroxy-4-n-octoxybenzophenone (e.g., UVASORB 3C); nickel dibutyl dithiocarbamate (e.g., UV-CHECK AM 104); 2,4-dihydroxybenzophenone (e.g., UVINUL 3000).

The UV absorbers and the UV stabilizers are optional components and can be excluded from the surface treatment composition. When the surface treatment composition includes a UV absorber or UV stabilizer, the UV absorber or UV stabilizer can be included in amounts of about 0.01 wt. % to about 1 wt. % based on the weight of the use composition, and can be included in amounts of about 0.02 wt. % to about 0.1 wt. % based on the weight of the use composition.

Antioxidants

The surface treatment composition can include an antioxidant to reduce oxidative damage by, for example, ozone, to a surface. Exemplary antioxidants that can be used include anthranilic acid; butylated hydroxy toluene (BHT); 2,2′-methylenebis-(4-methyl-6-tertiary-butylphenol)(CAO-5); 2,5-diterbutylhydroquinone (DTBHQ); hydroquinone monomethyl ether (HQMME); hydroquinone; monoterbutylhydroquinone (MTBHQ); erytorbic acid and its sodium salt; alkylated phenyl α-naphthylamine (e.g., IRGANOX L-06); tetrakis(methylene-3-(3′,5′-di-tert-butyl-4′-hydroxyphenyl)propionate)methane (e.g., IRGANOX 1010); 2,2′-methylene bis(4-methyl-6-tert-butylphenol)(Octolite 504); mono- and diisopropyl meta and para cresols (STABILIZER 9-A); butylated hydroxyanisol (BHA); butylated hydroxytoluene (BHT); propyl gallate (SUSTANE PG); tertiary butyl hydroquinone (TBHQ); and toluhydroquinone (THQ).

It should be understood that the oxidant is an optional component of the surface treatment composition and can be excluded from the surface treatment composition. When the surface treatment composition includes an antioxidant, it can be included in an amount of about 0.01 wt. % to about 1 wt. %, and can be included in an amount of about 0.05 wt. % to about 0.5 wt. % based on the weight of the use composition.

pH Modifiers

The surface treatment composition can include a pH modifier so that the composition has the desired pH. pH modifiers can include acids or bases, and can be organic or inorganic.

Exemplary inorganic acids that can be used include sulfuric acid, hydrochloric acid, phosphoric acid, bisulfate salts, sulfamic acid, nitric acid, carbonic acid, hydrobromic acid, hydrofluoric acid, and hydroiodic acid.

Exemplary organic acids that can be used include: acetic acid; oxalic acid; benzoic acid; acetoacetic acid; caproic acid; citric acid; formic acid; lactic acid; maleic acid; and fatty acids such as oleic acid, linoleic acid, and palmitic acid.

Exemplary inorganic bases that can be used include: sodium hydroxide; potassium hydroxide; magnesium hydroxide; lithium hydroxide; calcium hydroxide; barium hydroxide; aqueous ammonia; hydroxylamine; and zinc hydroxide.

Exemplary organic bases that can be used include: ethanolomines; alkylamines; alkyl phenylamines; alkylarylamines; phenyl arylamines; alkyldiamines; dialkyltriamines; urea; pyridine; picoline; morpholine; alkanolomines; alkyl alkanolamines.

The pH modifier is an optional component of the surface treatment composition and can be excluded from the surface treatment composition. When the pH modifier is included in the surface treatment composition, it can be included in an amount sufficient to provide the surface treatment composition (use composition) with a pH of about 1 to about 14, preferably about 5 to about 10, and more preferably about 6 to about 9.

Preservatives

The surface treatment composition can include a preservative to protect against microbial growth. For example, the preservative can be included to protect the surface treatment composition from microbial growth. Exemplary preservatives that can be included in the surface treatment composition include propylene glycol; propyl paraben (e.g., LEXGARD P); methyl paraben (e.g., LEXGARD M); imidazolidinyl urea (Abiol, termal 115); oxazolidine (BIOBAN CS-1246, OXABAN-E); substituted triazines (BIOBAN GK); 5-bromo-5-nitro-1,3-dioxane (BRONIDOX -L); 2-bromo-2-nitropropane-1,3-diol (bronopol); DMDM hydantoin (DANTOGARD, GLYDANT); 1-(3 chloroallyl)-3,5,7-triaza-1-azoniaadamantane chloride (DOWCIL 75); phenoxyethanol (EMERESSENCE 1160 ROSE ETHAR); diazolidinil urea (GERMALL II); iodopropynyl butyl carbamate (GLYCACIL); butyl paraben (LEXGARD B); 2,4-dichlorobenzyl alcohol (MYACIDE SP); 2-mercaptopyridine-1-oxide, sodium salt (SODIUM OMADINE); tetrahydro-3,5-dimethyl-2H-1,3,5-thiadiazine-2-thione (TROYSAN 142); 2-(hydroxymethyl)aminoethanol (TROYSAN 174); 2-(hydroxymethyl)amino-2-methyl-1-propanol (TROYSAN 186); 1,2-benzisothiazoline-3-one (TROYSAN 586); hexahydro-1,3,5-triethyl-s-triazine (VANCIDE TH); 2-mercaptopyridine-1-oxide, and zinc salt (ZINC OMADINE).

The preservative is an optional component of the surface treatment composition and can be excluded from the surface treatment composition. When the surface treatment composition includes a preservative, it can be included in an amount of about 0.1 wt. % to about 2 wt. %, and can be included in an amount of about 0.1 wt. % to about 1 wt. % based on the weight of the use composition.

Additional Components

The surface treatment composition can include additional components such as aesthetic agents and solidifying agents. Exemplary aesthetic aids include fragrances, or coloring agents such as dyes, lakes, or pigments. The aesthetic aid is an optional component and can be excluded from the surface treatment composition. When included in the surface treatment composition, the aesthetic aid can be provided in an amount sufficient to provide the desired aesthetic effect. The solidifying agent can be included to provide the surface treatment composition in the form of a solid in various forms including a solid block, solid pellet, solid tablet, etc. Exemplary solidifying agents include polyethylene glycol, urea, and hydrate donor/acceptor pairs such as those described in U.S. application Ser. No. 09/999,072 that was filed with the United States Patent and Trademark Office on Nov. 30, 2002. The entire disclosure of U.S. application Ser. No. 09/999,072 is incorporated herein by reference. It should be understood that the solidifying agent is an optional component and can be excluded from the surface treatment composition when it is not desirable for the surface treatment composition to be provided in the form of a solid. When the solidifying agent is included in the surface treatment composition, it is preferably included in an amount sufficient so that the surface treatment composition can be provided in a solid form. When provided as a solid, the surface treatment composition can be constructed so that it becomes liquefied by, for example, application of water or organic solvent to provide a use composition that is in a liquid or gel form. Alternatively, the surface treatment composition can be provided as a solid use composition in those situations where the solid form is intended to be applied directly to a surface. For example, the surface treatment composition can be provided in the form of a solid (e.g., a bar or tube) that can be applied directly to a tire sidewall as a result of rubbing on the tire sidewall.

The surface treatment composition can be provided in various forms for application to a surface. The surface treatment composition can be provided in the form of a ready to use composition or as a concentrate that can be diluted to provide a ready to use composition. Exemplary ready to use compositions include liquids, foams, solids, aerosols, liquid sprays, and gels. Exemplary concentrated compositions can be provided in the form of solids or liquids or gels that can be diluted to provide a ready to use composition.

The surface treatment composition can be applied to a surface in a variety of ways and using a variety applicators and equipment known to the art. Furthermore, the surface treatment composition can be applied to a clean surface or it can be applied to a soiled surface, and it can be applied to a dry surface or a wet surface. It may be desirable to apply the surface treatment composition to a clean and wet surface. The wetness of the surface may be a result of rinsing the surface after cleaning. In the case of an aqueous surface treatment composition, it is expected that the surface treatment composition can be applied to the surface more advantageously if the surface is wet rather than dry. Furthermore, in the case of a nonaqueous surface treatment composition, it is expected that the surface treatment composition may displace the water on the surface when applied to a wet surface. In the case of the surface treatment composition being provided as a tire dressing composition for application to the sidewall of a tire, the tire dressing composition can be applied to a clean or soiled tire, and a wet or dry tire. It may be desirable to apply the tire dressing composition to the tire sidewall after the vehicle and the tires have been washed in a commercial vehicle washing facility. After washing in a commercial vehicle washing facility, the tires can be clean and wet. The tire dressing composition can be applied mechanically or manually. A foam applicator (e.g., sponge) can be used to apply the tire dressing composition. The foam applicator can be provided having a curved surface that corresponds with the curve on the tire sidewall. The tire dressing composition can be contained within the foam applicator within, for example, a reservoir in the foam applicator, or the tire dressing composition can be absorbed into the foam applicator or allowed to penetrate into the foam applicator. For example, the tire dressing composition can be squirted onto the surface of the foam applicator or into the interior of the foam applicator and allowed to become released from the foam applicator to cover the tire sidewall. In addition, the tire dressing composition can be sprayed or squirted onto the tire and a sponge, cloth, pad, or brush can be used to level the composition and remove excess composition. When provided in the form of a gel or solid ready-to-use composition, the tire dressing composition can be applied directly to the tire surface by, for example, rubbing.

Several commercially available tire dressing compositions include silicone such as organopolysiloxane as a component of the composition to provide a glossy appearance. The surface treatment composition according to the invention can provide a surface with a desired glossy appearance as a result of the nonsilicone gloss imparting component. The surface treatment composition can be provided so that when it is available in the form of a use composition, the surface treatment composition contains less than about 5 wt. % silicone. In addition, the surface treatment composition can contain less than about 1 wt. % silicone. The surface treatment composition can contain no silicone. The reference to a use composition refers to the composition in a form for application to a surface to provide an increased gloss value. The surface treatment composition can be made available as a concentrate that can be diluted to form a use composition and applied to a surface. The reference to “silicone” refers to components characterized as organopolysiloxanes.

The surface treatment composition can include a silicone component, if desired, in addition to the nonsilicone gloss imparting component. The presence of a silicone component may be desirable because to increase the glossy appearance of the surface. In general, the cost of silicone can be fairly expensive relative to other components that can be used to impart gloss. By including a nonsilicone gloss imparting component in the surface treatment composition, it may be possible to decrease the amount of silicone used to achieve a desired glossy appearance. A nonsilicone gloss imparting component and a silicone component can be combined to provide a desired glossy appearance while reducing the amount of the silicone component that would be necessary to achieve the same glossy appearance without the presence of the nonsilicone gloss imparting component. When the surface treatment composition includes a silicone component, the silicone component can be included in an amount of about 1 wt. % to about 60 wt. %. In addition, the surface treatment composition can include about 1 wt. % to about 30 wt. % of the silicone component, and can include about 35 wt. % to about 50 wt. % of the silicone component. It should be understood that the ranges are based upon the surface treatment composition being provided as a use composition.

Various silicone components that can be used include siloxanes such as polydimethyl siloxanes, amino silicones, and polymethylalkyl siloxanes. Exemplary polyldimethyl siloxanes are disclosed in U.S. Pat. No. 3,956,174 and U.S. Pat. No. 4,133,921. In general, polydimethyl siloxanes that can be used include those having the following formula: 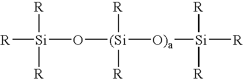
wherein R is a methyl radical and a is 1 to about 3,000. Exemplary polymethylalkyl siloxanes include those described by U.S. Pat. No. 4,640,792 and U.S. Pat. No. 5,017,221. Exemplary polymethylalkyl siloxanes include those having the formula: 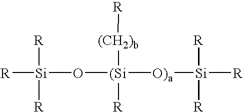
wherein R is a methyl radical, a is 1 to about 3,000, and b is 1 to about 10.

The surface treatment composition can provide increased lubricity of a surface. The increase in lubricity can be reflected by a decrease in coefficient of friction. In general, the coefficient of friction between two surfaces is the ratio of the force required to move one surface over the other to the total force pressing the two together (CRC Handbook of Chemistry and Physics, 53rd Edition, 1972-1973, Page F-15). An increase in lubricity can be demonstrated by a reduction in coefficient of friction of at least 1% compared to the use of water. That is, the surface treatment composition can provide a reduction in coefficient of friction compared to the use of water that is at least 1% or more. Accordingly, the surface treatment composition can be used on various surfaces commonly found in container processing so that the surface treatment composition can be used as a “chain lube” or “conveyor lube.” Various surfaces found on containers include glass, aluminum, and plastic such as polyethylene and polyethylene terephthalate. The determination of coefficient of friction can be provided according to ISO 8295:1995 or ASTM G1 5-04.

### EXAMPLE 1

### Aqueous Tire Dressing Composition

An aqueous tire dressing composition was prepared from the components identified in Table 1 as Composition A. The composition was provided in the form of an emulsion, and applied to a tire surface. The resulting tire surface exhibited desired gloss and water resistance.

TABLE 1
Composition A

| Component | Wt. % |
|---|---|
| Water | 73.45 |
| Polypropylene glycol, mw 4000 | 25.00 |
| PEMULEN 1622 | 0.15 |
| MIRANOL C2M-SF | 0.20 |
| propoxylated quaternary ammonium chloride | 1.00 |
| monoethanolamine | 0.10 |
| preservative | 0.10 |

PEMULEN 1622 is a polymeric thickener/emulsifier available from Noveon.
MIRANOL C2M-SF is an amphoteric surfactant available from Rhodia.
The propoxylated quaternary ammonium chloride is available under the name VARIQUAT CC42NS.

The water resistance was measured by placing a small pool of water on the treated tire for 5 minutes and then soaking up the water with the edge of a paper towel. A loss of gloss in the wetted area corresponds to poor water resistance, and no loss of gloss corresponds to good water resistance. In this example, no loss of gloss was noted after the water resistance test.

The 60 degree gloss of one coat and of two coats of Composition A was compared to the 60 degree gloss of two coats of a commercial tire dressing composition available under the name Black Magic® Tire Wet® from Blue Coral-Slick 50, Ltd. on a Bridgestone tire. As the below data illustrates, even one coat of the Composition A provided superior gloss compared with two coats of the commercial tire dressing composition. The 60 degree gloss was measured by using a Gardner Gloss Meter that measures reflectance of light at 60 degrees.

TABLE 2

| Composition | Gloss |
|---|---|
| Composition A, 1 coat | 4.5 |
| Composition A, 2 coats | 6.5 |
| Black Magic Tire Wet, 2 coats | 2.5 |

### EXAMPLE 2

### Aqueous Tire Dressing Composition

An aqueous tire dressing composition identified as Composition B in Table 3 was prepared and applied to a tire, and provided good gloss and water resistance. Composition B includes a water-soluble polypropylene glycol, mw 425, to help emulsify an essentially water-insoluble polypropylene glycol, mw 1200.

TABLE 3
Composition B

| Component | Wt. % |
|---|---|
| Water | 74.45 |
| polypropylene glycol, mw 425 | 20.00 |
| polypropylene glycol, mw 1200 | 5.00 |
| PEMULEN 1622 | 0.20 |
| MIRANOL C2M-SF | 0.20 |
| monoethanolamine | 0.15 |

### EXAMPLE 3

### Nonaqueous Tire Dressing Composition

A tire dressing composition identified as Composition C in Table 4 was prepared and applied to a tire. The resulting tire surface exhibited good gloss and water resistance.

TABLE 4
Composition C

| Component | Wt. % |
|---|---|
| mineral spirits | 90.00 |
| polypropylene glycol, mw 3000 | 10.00 |

### EXAMPLE 4

### Low VOC Nonaqueous Tire Dressing Composition

A tire dressing composition identified as Composition D in Table 5 was prepared and applied to a tire. The resulting tire surface exhibited good gloss and good water resistance.

TABLE 5
Composition D

| Component | Wt. % |
|---|---|
| ISOPAR K | 90.00 |
| polypropylene glycol, mw 3000 | 10.00 |

ISOPAR K is a low VOC (volatile Organic compound) containing paraffinic oil available from Exxon.

### EXAMPLE 5

### Nonaqueous Tire Dressing Composition

A tire dressing composition identified as Composition E was prepared and applied to a tire. The resulting tire surface exhibited very dark, matte black appearance.

TABLE 6
Composition E

| Component | Wt. % |
|---|---|
| mineral spirits | 90.00 |
| canola oil | 10.00 |

### EXAMPLE 6

### Solvent-Free Tire Dressing Composition

A tire dressing composition identified as Composition F in Table 7 was prepared and applied to a tire. The resulting tire surface exhibited very dark, matte black appearance and good water resistance.

TABLE 7
Composition F

| Component | Wt. % |
|---|---|
| canola oil | 90.00 |
| polypropylene glycol, mw 1200 | 10.00 |

### EXAMPLE 7

### Absorption into a Tire

Small sections of sidewall from a Goodyear Wrangler tire were weighed and then placed into ajar with about 30-40 mL of test materials. The jars were then heated in a 120° F. oven for 24 hours and the section of tire was recovered, wiped dry, and reweighed. The weight change in the tire was then calculated. The results are reported in Table 8. As the below data illustrates, the silicone replacements have an absorption rate into a tire similar to that of a silicone.

TABLE 8

| Test Materials | Wt. % |
|---|---|
| DOW CORNING 200 FLUID (silicone oil) | −0.8 |
| soy methyl ester | +47.0 |
| polypropylene glycol, mw 1200 | +0.06 |
| canola oil | +0.42 |
| polyisobutylene, mw 1000 | +0.02 |

DOW CORNING 200 FLUID is a silicone fluid available from Dow Corning.

The test shows that polypropylene glycol (MW1200), canola oil, and polyisobutylene (MW 1000) provide an absorption rate into a tire similar to that of a silicone oil.

### EXAMPLE 8

### Performance Comparison of Tire Dressing Compositions

Two compositions (Composition G containing 100% canola oil and Composition H containing 90% canola oil and 10% polypropylene glycol (mw 1200)) were compared to commercial tire dressing compositions for a variety of performance properties on a ½ inch thick slab of ethylene/propylene/diene (EPDM) rubber. The gloss of each dressing was measured at 20, 60, and 85 degree angles using a Gardner Gloss Meter. It was noted whether or not the treated area was susceptible to mechanical loss of gloss by whether or not a fingerprint was left after touching it. Then potting soil was sprinkled over the treated area and rinsed off with water and the rubber allowed to air dry before remeasuring the gloss.

The results of this test are reported in Table 9. Compositions G and H exhibit desired gloss values for original gloss (gloss before soil) and resistance to soiling/rinsing away (gloss after soil).

TABLE 9

| | | | Gloss Before Soil | | | Gloss After Soil | | |
|---|---|---|---|---|---|---|---|---|
| | Fingerprints | % Absorbed | 20 | 60 | 85 | 20 | 60 | 85 |
| Untreated | no | N/A | 0.6 | 8.0 | 54.4 | 0.5 | 7.3 | 56.3 |
| Meguiar Hot Shine | yes | 19.7 | 6.0 | 30.6 | 72.1 | 6.8 | 33.1 | 65.6 |
| Turtlewax Wet'n Black | yes | 30.9 | 9.8 | 36.1 | 73.3 | 8.3 | 32.8 | 63.8 |
| Armor All Original | yes | 1.3 | 7.9 | 37.6 | 75.0 | 7.2 | 34.9 | 68.5 |
| Ecolab Ultra Black | no | 4.6 | 1.3 | 14.7 | 64.9 | 5.8 | 28.4 | 64.5 |
| Composition G | no | <1% | 12.5 | 41.3 | 77.8 | 14.2 | 41.9 | 70.7 |
| Composition H | no | <1% | 11.4 | 37.6 | 74.1 | 12.5 | 38.0 | 68.4 |

### EXAMPLE 9

### Treatment of Plastic

Composition A from Example 1 was applied to the plastic bumper of a Toyota Tundra vehicle. The treated area had visibly improved gloss and appeared a darker, richer black in color.

### EXAMPLE 10

### Treatment of Wood

An interior door was treated with Composition A from Example 1. The treated area had visibly enhanced gloss and also water repellency as shown by beading of water applied from a spray bottle.

### EXAMPLE 11

### Enhancement of Lubricity

A sheet of polycarbonate was treated with various compositions and its lubricity measured with a Chattilon Horizontal Slip Tester. The results are reported in Table 10. Treatment of the surface with water had no effect on lubricity, and treatment with a 10% dilution of Composition A of Example 1 in water provided improved lubricity.

TABLE 10

| Treatment | Lubricity Meter Reading |
|---|---|
| none | 1.5 |
| water | 1.5 |
| 10% Composition A | 1.0 |

### EXAMPLE 12

### Tire Dressing with Nonsilicone Gloss Imparting Agent and Silicone Gloss Imparting Agent

A composition as shown in Table 11 was prepared and applied to a Dunlop tire. The composition was a dry to touch and provided a high gloss shine that resisted rinsing away during two days of rain.

TABLE 11

| Component | Wt. % |
|---|---|
| water | 48.69 |
| EO-PO copolymer | 0.98 |
| Dow Corning 346 Emulsion (silicone emulsion) | 23.76 |
| Down Corning 929 Emulsion (silicone emulsion) | 1.43 |
| canola oil | 23.76 |
| polyacrylate thickener | 0.98 |
| preservative | 0.10 |
| monoethanolamine | 0.30 |

The above specification, examples and data provide a complete description of the manufacture and use of the composition of the invention. Since many embodiments of the invention can be made without departing from the spirit and scope of the invention, the invention resides in the claims hereinafter appended.

1. A surface treatment composition comprising:
(a) nonsilicone gloss imparting component in an amount sufficient so that the surface treatment composition, when applied to a surface, provides the surface with an increased gloss value compared with the surface prior to application of the composition wherein the nonsilicone gloss imparting component exhibits a solubility in water of less than about 5 wt. % a glass transition temperature or melting point of less than about 0° C. and a refractive index of greater than about 1.40;
(b) wetting agent in an amount sufficient so that the composition, when applied to the surface, provides a contact angle between the surface treatment composition and the surface of less than 90°; and
(c) at least about 40 wt. % water based on the weight of the surface treatment composition.

2-3. (canceled)

4. A surface treatment composition according to claim 1, wherein the nonsilicone gloss imparting component comprises at least one of a polymer or organic polar compound having two or more ester groups.

5. A surface treatment composition according to claim 1, wherein the nonsilicone gloss imparting component comprises at least one of polypropylene glycol, polybutylene glycol, polyisobutylene, polypropylene, polyethylene, polybutylene, polydecene, or copolymers thereof

6-7. (canceled)

8. A surface treatment composition according to claim 5, wherein the polar compound having two or more ester groups comprises glyceride.

9. A surface treatment composition according to claim 8, wherein the glyceride comprises at least one of canola oil, rape seed oil, olive oil, soybean oil, or corn oil.

10. A surface treatment composition according to claim 1, wherein the nonsilicone gloss imparting component comprises polypropylene glycol having a molecular weight of about 1,000 to about 10,000.

11. A surface treatment composition according to claim 1, wherein the composition comprises about 1 wt. % to about 50 wt. % of the nonsilicone gloss imparting component.

12-14. (canceled)

15. A surface treatment composition according to claim 1, wherein the composition comprises about 0.1 wt. % to about 10 wt. % of the wetting agent

16. A surface treatment composition according to claim 1, wherein the composition comprises about 0.2 wt. % to about 2 wt. % of the wetting agent.

17. A surface treatment composition according to claim 1, wherein the composition comprises about 0.1 wt. % to about 2 wt. % of a thickening agent.

18. A surface treatment composition according to claim 1, wherein the composition comprises at least about 60 wt. % of the water.

19-24. (canceled)

25. A surface treatment composition according to claim 1, further comprising about 0.1 wt. % to about 20 wt. % film forming agent.

26. A surface treatment composition according to claim 1, further comprising about 0.01 wt. % to about 1 wt. % antioxidant.

27. A surface treatment composition according to claim 1, wherein the surface treatment composition exhibits an increased gloss value of at least about 5% when provided on a tire surface and measured at 60° using a Gardner gloss meter compared with the surface prior to application of the surface treatment composition.

28-29. (canceled)

30. A surface treatment composition according to claim 1, wherein the composition provides a glass, aluminum or plastic surface with at least a 1% reduction in coefficient of friction compared with water.

31. A surface treatment composition comprising:
(a) nonsilicone gloss imparting component in an amount sufficient so that the surface treatment composition, when applied to a surface, provides the surface with an increased gloss value compared with the surface prior to application of the composition wherein the nonsilicone gloss imparting component exhibits a solubility in water of less than about 5 wt. %, a glass transition temperature or melting point of less than about 0° C., and a refractive index of greater than about 1.40; and
(b) organic solvent, wherein the nonsilicone gloss imparting component and the organic solvent are different.

32-33. (canceled)

34. A surface treatment composition according to claim 31, wherein the solvent comprises a nonpolar solvent.

35. (canceled)

36. A surface treatment composition according to claim 31, wherein the organic solvent comprises a polar solvent.

37-38. (canceled)

39. A surface treatment composition according to claim 31, wherein the composition comprises about 0.5 wt. % to about 40 wt. % of the organic solvent.

40-71. (canceled)

72. A surface treatment composition comprising:
(a) first nonsilicone gloss imparting component selected from at least one of polyalkylene glycol, polyolefin, or triglyceride; and
(b) second nonsilicone gloss imparting component comprising at least one of polyalkylene glycol, polyolefin, or triglyceride; and
(c) wherein the first nonsilicone gloss imparting component and the second nonsilicone gloss imparting component are different.

73-79. (canceled)
